(19) United States
(12) Patent Application Publication
(10) Pub. No.: US 2026/0036950 A1
(43) Pub. Date: Feb. 5, 2026

(54) METHOD AND SYSTEM FOR MANAGING FLARING USING MACHINE LEARNING (ML) MODEL

(71) Applicant: Honeywell International Inc., Charlotte, NC (US)

(72) Inventors: Junda Zhu, Atlanta, GA (US); Aishwarya Coffey, Dublin (IE); Sahil Vartak, Atlanta, GA (US); Tarun Mirani, Decatur, GA (US); Sabina Azizli, Fulshear, TX (US); Rakesh Venuturumilli, Phoenix, AZ (US)

(21) Appl. No.: 18/793,952

(22) Filed: Aug. 5, 2024

(51) Int. Cl. G05B 13/02

(52) U.S. Cl. CPC G05B 13/028

(57) ABSTRACT

A method for managing flaring using a machine learning (ML) model is disclosed. The method comprising receiving, via at least one processor, flare data from one or more flare stacks in real time; determining, via the at least one processor, one or more peaks within the flare data, using the ML model; categorizing, via the at least one processor, the flare data into a routine flaring and a non-routine flaring; predicting, via the at least one processor, flare events within the flare data, based at least on a historical data and a set of parameters; determining, via the at least one processor, one or more parameter setpoints and advisory information associated with the predicted flare events; and deploying, via the at least one processor, the determined one or more parameter setpoints and the advisory information on each of the one or more flare stacks, to manage the flaring.

### TECHNOLOGICAL FIELD

The present invention relates to managing a flaring, and more particularly relates to a system and method for managing the flaring using a machine learning (ML) model.

### BACKGROUND

Flaring is a common practice in various industries such as oil and gas, petrochemical, and landfill management. Flaring is a process of burning excess gases. In the oil and gas industry, flaring is usually performed during production, processing, and transportation of hydrocarbons. Further, the flaring is utilized to manage waste gases, relieve pressure, and ensure safety by preventing an accumulation of flammable gases. In petrochemical industry, flaring is employed to dispose of excess or byproduct gases that are generated during chemical processes. The flaring is categorized into a routine flaring and a non-routine flaring. The routine flaring is a regular operational practices often used to manage gas that are unable to be economically captured or utilized. The non-routine flaring occurs during unexpected events such as equipment malfunctions, process upsets, or emergency shutdowns. Typically, the non-routine flaring is of shorted duration but involves a larger volume of gas and is performed to ensure safety and prevent damage to equipment or environment.

The routine and the non-routine flaring events are not only wasteful but also significantly impact an environmental, social, and governance (ESG) performance of various industries. Additionally, the routine flaring events that generally occurs due to various unwanted circumstances such as equipment failures or process upsets, must comply with stringent environmental protection agency (EPA) requirements to ensure that such routine flaring events are conducted safely and economically. Typically, for distinguishing between the routine and the non-routine flaring events, a manual approach is involved. The manual approach relies primarily on the operational team's expertise and knowledge. Such manual approach is not only labor-intensive but also lacks scalability.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In one example embodiment, a method for managing flaring using a machine learning (ML) model is disclosed. The method comprising receiving, via at least one processor, flare data from one or more flare stacks in real time. Further, the flare data corresponds to mass or volume of gas flared within each of the one or more flare stacks, temperature of the gas flared, and pressure at which the gas is flared. Further, the method comprises determining, via the at least one processor, one or more peaks within the flare data, using the ML model. Further, the one or more peaks having one or more parameters. Further, the method comprises categorizing, via the at least one processor, the flare data of each of the one or more flare stacks into a routine flaring and a non-routine flaring, based at least on the one or more determined peaks having the one or more parameters, using the ML model. Further, the method comprises predicting, via the at least one processor, one or more flare events within the flare data categorized in the routine flaring and the non-routine flaring, based at least on a historical data and a set of parameters, using the ML model. The one or more flare events correspond to one or more peaks in flaring. The method further comprises determining, via the at least one processor, one or more parameter setpoints and advisory information associated with the predicted one or more flare events. Thereafter, the method comprises deploying, via the at least one processor, the determined one or more parameter setpoints and the advisory information on each of the one or more flare stacks, to manage the flaring.

In some embodiments, the method further comprises training, via the at least one processor, the ML model based at least on the historical data for predicting the one or more peaks in the flaring. Further, the historical data corresponds to a repository of the flare data received from each of the one or more flare stacks within a predefined time period.

In some embodiments, the one or more parameters of the one or more peaks comprise at least one of start and stop time of the one or more peaks. The set of parameters comprises at least one of temperature and pressure of one or more components associated with each of the one or more flare stacks, control data, economics data, or compliance data.

In some embodiments, the method further comprises determining, via the at least one processor, one or more defective components from the one or more components associated with each of the one or more flare stacks, based at least on the prediction.

In some embodiments, the method further comprises generating, via the at least one processor, one or more alerts corresponding to the one or more parameter setpoints, the advisory information, and the one or more defective components, for a user.

In some embodiments, the one or more parameter setpoints comprise at least one of change in pressure of upstream vessels of the one or more flare stacks, change in temperature of upstream vessels of the one or more flare stacks, or change in speed of rotating machinery of the one or more flare stacks. In some embodiments, the advisory information corresponds to guidance and recommendations for an operation of each of the one or more flare stacks based at least on compliance and economics of each of the one or more flare stacks, to eliminate or minimize the non-routine flaring.

In another example embodiment, a system for managing flaring using a machine learning (ML) model is disclosed. The system comprises a memory and at least one processor communicatively coupled to the memory. The at least one processor is configured to receive flare data from one or more flare stacks in real time. The flare data corresponds to mass or volume of gas flared within each of the one or more flare stacks, temperature of the gas flared, and pressure at which the gas is flared. Further, the at least one processor is configured to determine one or more peaks within the flare data, using the ML model. Further, the one or more peaks having one or more parameters. Further, the at least one processor is configured to categorize the flare data of each of the one or more flare stacks into a routine flaring and a non-routine flaring, based at least on the one or more determined peaks having the one or more parameters, using the ML model. Further, the at least one processor is configured to predict one or more flare events within the flare data categorized in the routine flaring and the non-routine flaring, based at least on a historical data and a set of parameters, using the ML model. Further, the one or more flare events correspond to one or more peaks in flaring. Further, the at least one processor is configured to determine one or more parameter setpoints and advisory information associated with the predicted one or more flare events. Thereafter, the at least one processor is configured to deploy the determined one or more parameter setpoints and the advisory information on each of the one or more flare stacks, to manage the flaring.

In another example embodiment, a non-transitory machine-readable information storage medium for managing the flaring using a machine learning (ML) model is disclosed. The non-transitory machine-readable information storage medium comprising one or more instructions which when executed by at least one processor cause the at least one processor to receive flare data from one or more flare stacks in real time, wherein the flare data corresponds to mass or volume of gas flared within each of the one or more flare stacks, temperature of the gas flared, and pressure at which the gas is flared; determine one or more peaks within the flare data, using a machine learning (ML) model, wherein the one or more peaks having one or more parameters; categorize the flare data of each of the one or more flare stacks into a routine flaring and a non-routine flaring, based at least on the one or more determined peaks having the one or more parameters, using the ML model; predict one or more flare events within the flare data categorized in the routine flaring and the non-routine flaring, based at least on a historical data and a set of parameters, using the ML model, wherein the one or more flare events correspond to one or more peaks in flaring; determine one or more parameter setpoints and advisory information associated with the predicted one or more flare events; and deploy the determined one or more parameter setpoints and the advisory information on each of the one or more flare stacks, to manage the flaring.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRA WINGS

Having thus described certain example embodiments of the present disclosure in general terms, reference will hereinafter be made to the accompanying drawings, which are not necessarily drawn to scale, and wherein:

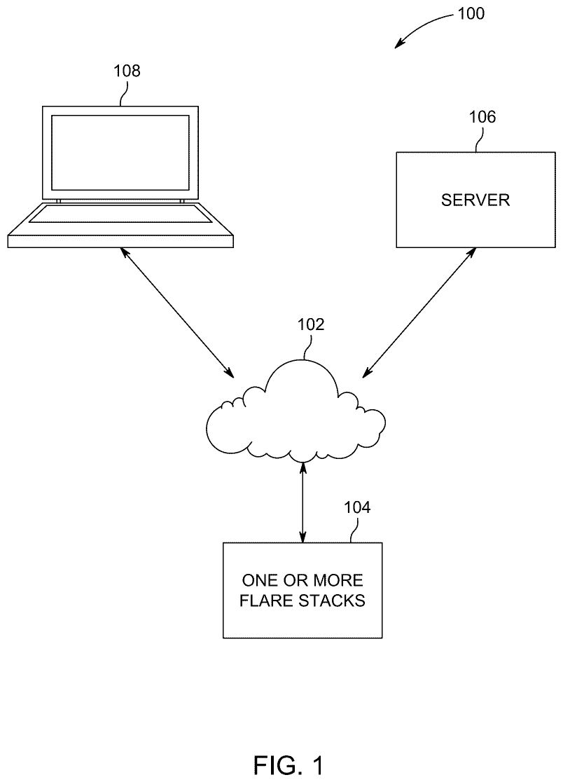

FIG. 1 illustrates a network diagram of a system for managing flaring using a machine learning (ML) model in accordance with an example embodiment of the present disclosure;

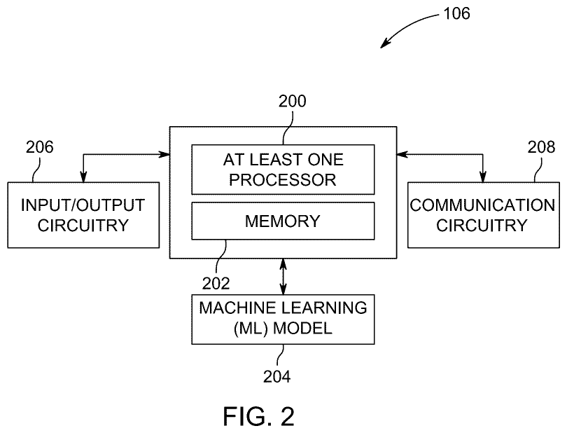

FIG. 2 illustrates a block diagram of a server of the system in accordance with an example embodiment of the present disclosure;

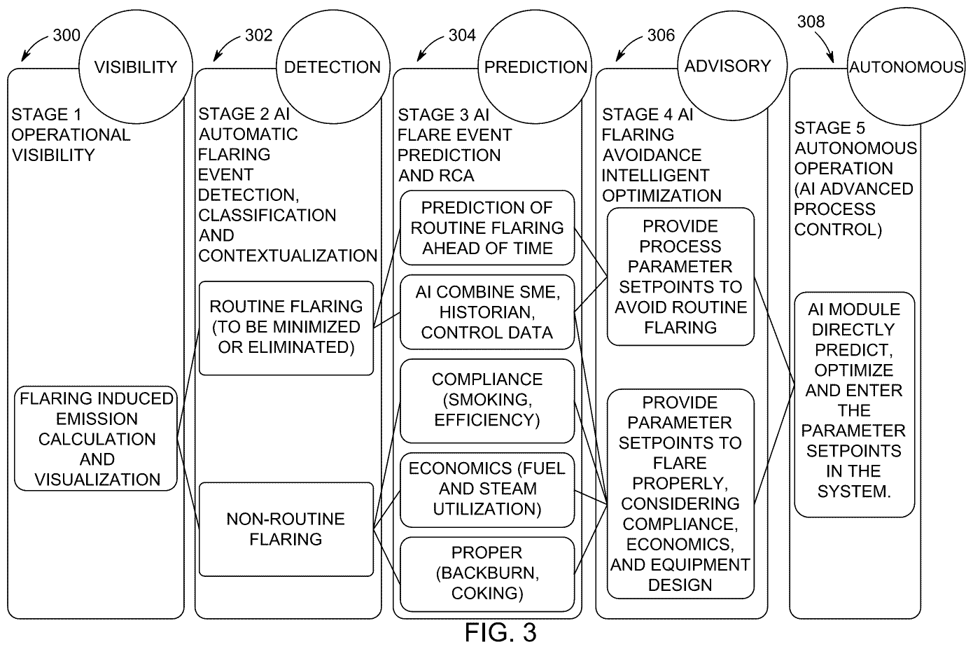

FIG. 3 illustrates a block diagram showing different stages of the system for managing the flaring in accordance with an example embodiment of the present disclosure;

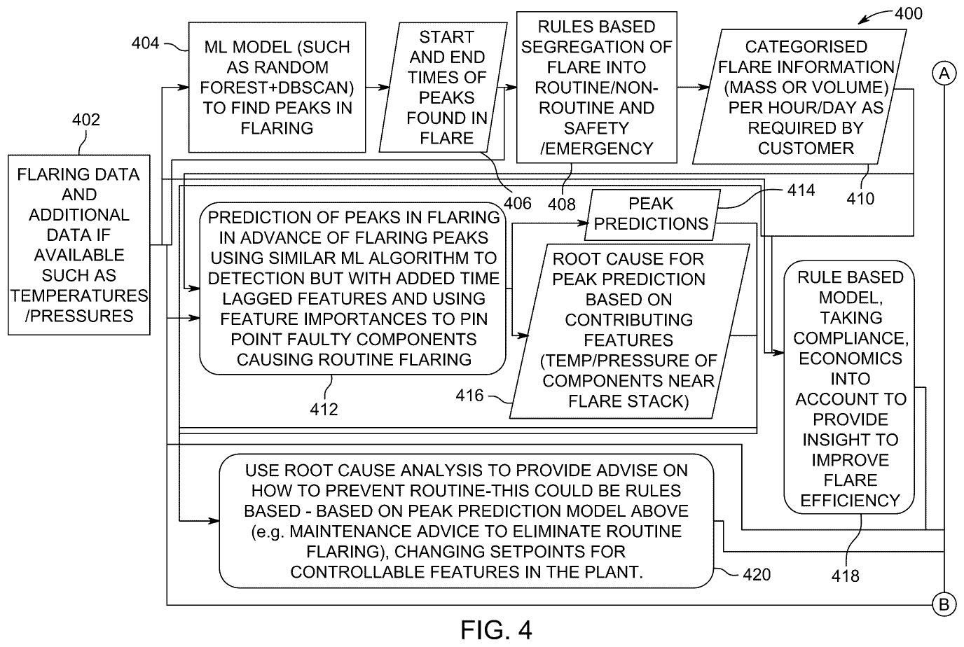

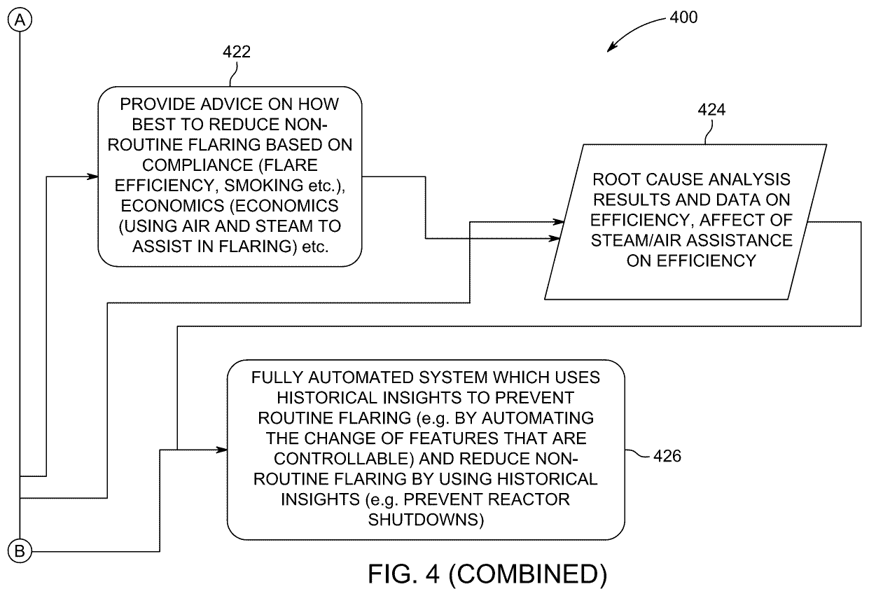

FIG. 4 illustrates a detailed flowchart showing a method for managing the flaring within one or more flare stacks using the ML model in accordance with an example embodiment of the present disclosure;

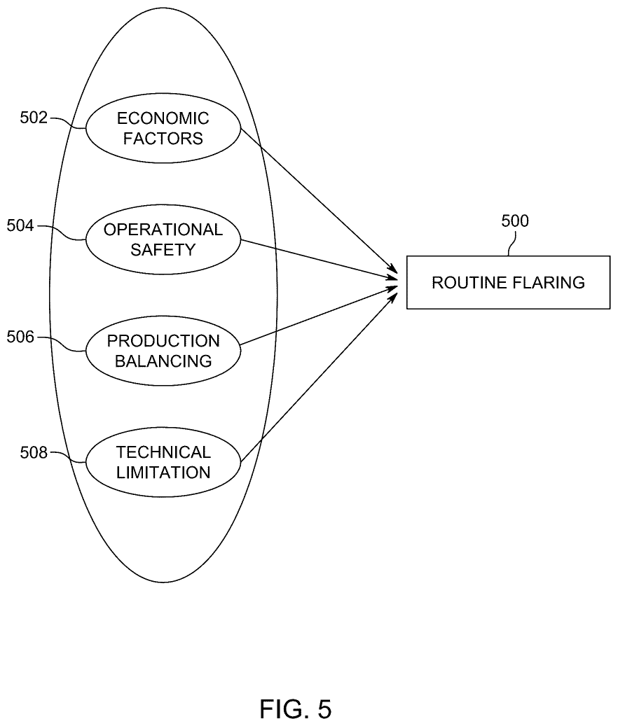

FIG. 5 illustrates a block diagram showing one or more conditions that lead to a routine flaring in accordance with an example embodiment of the present disclosure;

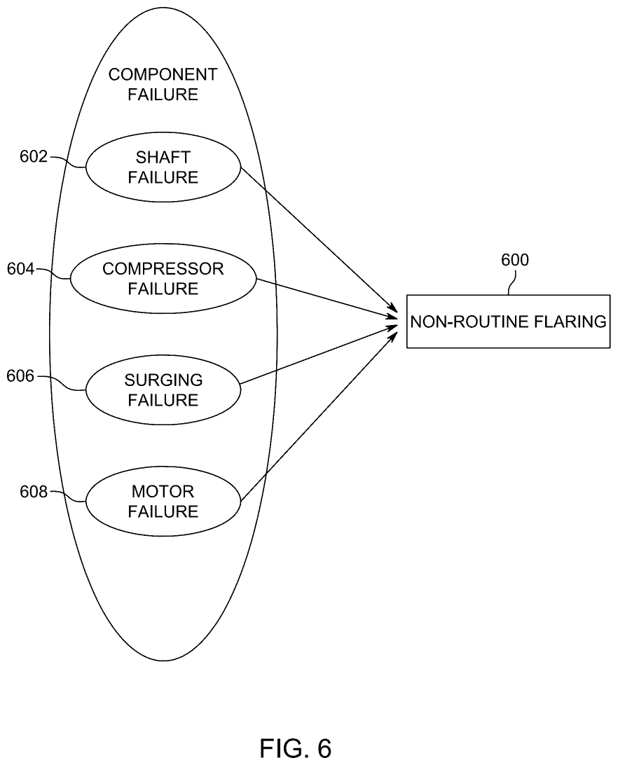

FIG. 6 illustrates a block diagram showing one or more component failures that lead to a non-routine flaring in accordance with an example embodiment of the present disclosure;

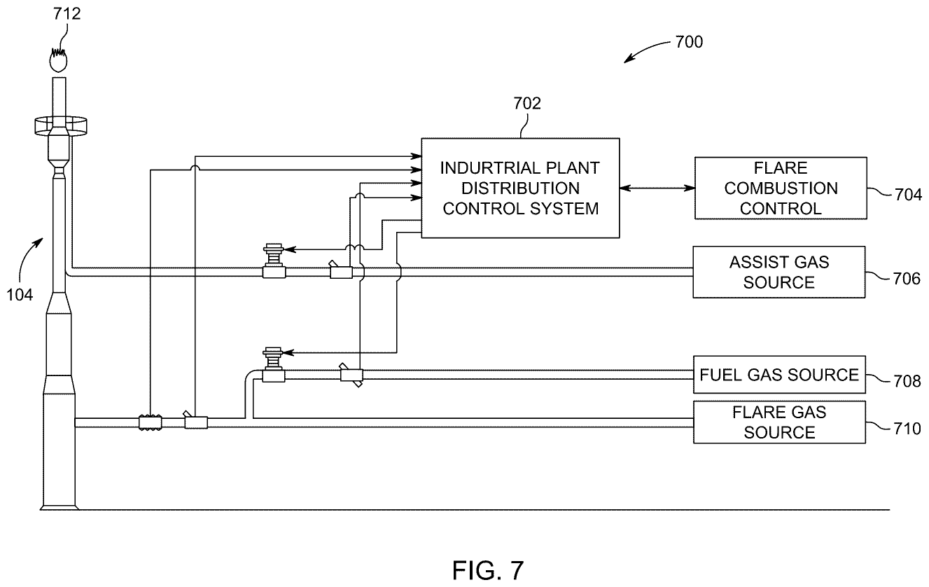

FIG. 7 illustrates an exemplary scenario of an industrial setting having one or more flare stacks in accordance with an example embodiment of the present disclosure;

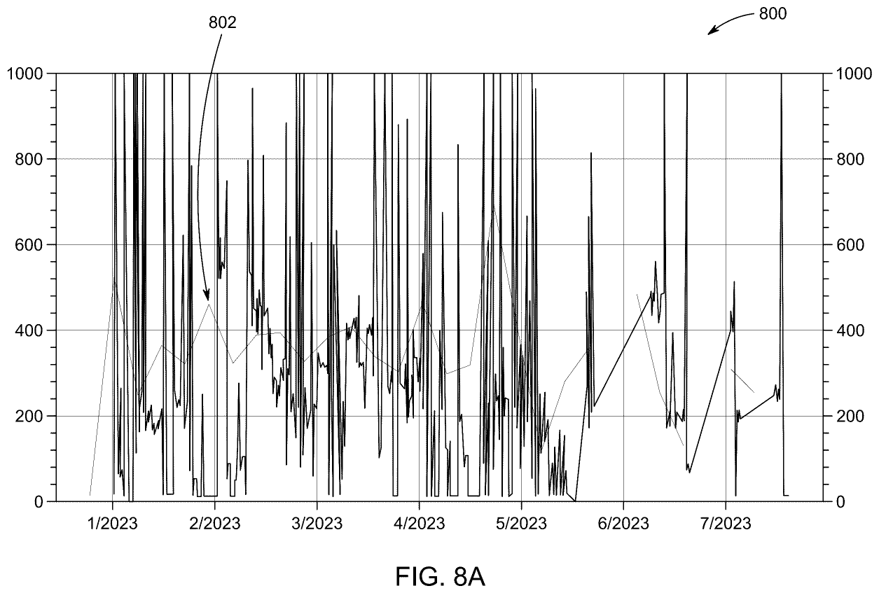

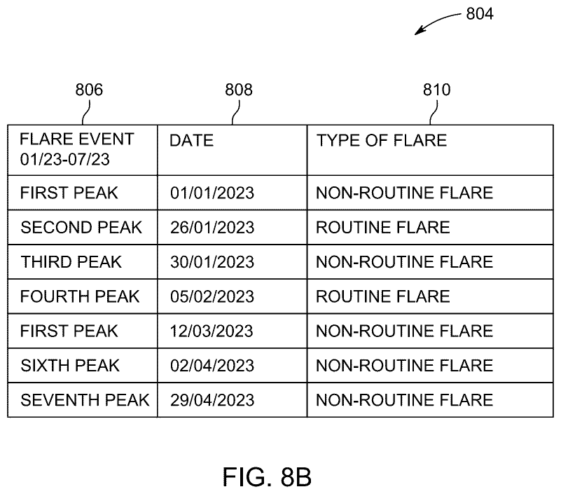

FIG. 8A illustrates a graphical representation showing response of the system for managing the flaring using the ML model in accordance with an example embodiment of the present disclosure;

FIG. 8B illustrates a table having data related to the response of the system for managing the flaring in accordance with an example embodiment of the present disclosure; and

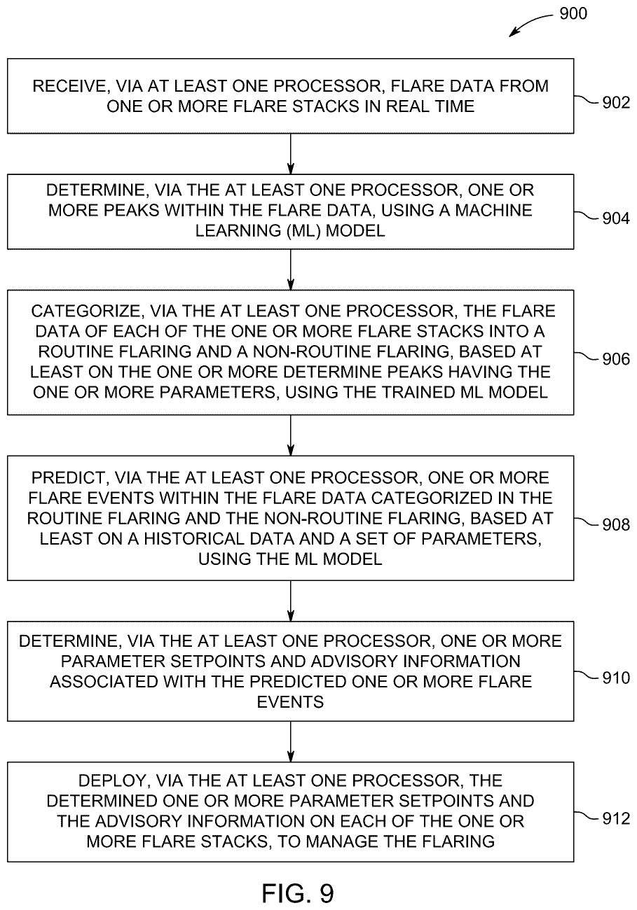

FIG. 9 illustrates a flowchart showing a method for managing the flaring using the ML model in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the invention described herein such that embodiments may include fewer or more components than those shown in the figures while not departing from the scope of the invention. Some components may be omitted from one or more figures or shown in dashed line for visibility of the underlying components.

The present disclosure provides various embodiments of methods and systems for managing flaring using a machine learning (ML) model. Embodiments may be configured to receive flare data from one or more flare stacks in real time by at least one processor. The flare data may correspond to mass or volume of gas flared within each of the one or more flare stacks, temperature of the gas flared, and pressure at which the gas is flared. Embodiments may be configured to determine one or more peaks within the flare data, using a machine learning (ML) model. The one or more peaks having one or more parameters that may comprise at least one of start and stop time of the one or more peaks. Embodiments may be configured to categorize the flare data of each of the one or more flare stacks into a routine flaring and a non-routine flaring, based at least on the one or more determined peaks having the one or more parameters, using the ML model. Embodiments may be configured to predict one or more flare events within the flare data categorized in the routine flaring and the non-routine flaring, based at least on a historical data and a set of parameters, using the ML model. The one or more flare events may correspond to one or more peaks in flaring. The set of parameters may comprise at least one of temperature and pressure of one or more components associated with each of the one or more flare stacks, control data, economics data, or compliance data.

Embodiments may be configured to train the ML model based at least on the historical data for predicting the one or more peaks in the flaring. The historical data may correspond to a repository of the flare data received from each of the one or more flare stacks within a predefined time period. Embodiments may be configured to determine one or more parameter setpoints and advisory information associated with the predicted one or more flare events. The one or more parameter setpoints may comprise at least one of change in pressure of upstream vessels of the one or more flare stacks, change in temperature of upstream vessels of the one or more flare stacks, or change in speed of rotating machinery of the one or more flare stacks. The advisory information may correspond to guidance and recommendations for an operation of each of the one or more flare stacks based at least on compliance and economics of each of the one or more flare stacks, to eliminate or minimize the non-routine flaring. Embodiments may be configured to determine one or more defective components from the one or more components associated with each of the one or more flare stacks, based at least on the prediction. Embodiments may be configured to generate one or more alerts corresponding to the one or more parameter setpoints, the advisory information, and the one or more defective components, for a user. Embodiments may be configured to deploy the determined one or more parameter setpoints and the advisory information on each of the one or more flare stacks, to manage the flaring.

FIG. 1 illustrates a network diagram of a system 100 for managing flaring using a machine learning (ML) model, in accordance with an example embodiment of the present disclosure. The system may comprise a network 102 and one or more flare stacks 104. The system 100 may further comprise a server 106 and a user device 108.

In some embodiments, the network 102 may be a communication network, such as the Internet or a cloud network, configured to enable communication between various computing devices and processing systems through wired, wireless, or hybrid connections. Further, the network 102 may also correspond to a distributed infrastructure designed for the exchange of data, information, and resources among interconnected computing devices and systems. The network 102 may facilitate communication and collaboration across remote locations, devices, and platforms. Those skilled in the art will understand that wired networks may include, but are not limited to, wired networks such as wide area networks (WANs) or local area networks (LANs). Further, wireless networks, on the other hand, may use wireless communications via radio frequency (RF) signals or infrared signals. Furthermore, various devices within the system 100 may connect to the network 102 using an array of wired and wireless communication protocols, such as Transmission Control Protocol/Internet Protocol (TCP/IP), User Datagram Protocol (UDP), and 2G, 3G, or 4G communication protocols.

Further, the one or more flare stacks 104 may be installed within an industrial setting (not shown). In some embodiments, the industrial setting may comprise one or more facilities that are designed to transform raw materials into finished goods. In some embodiments, the one or more facilities utilize one or more processes to transform the raw materials into the finished goods. Further, the one or more processes include, but are not limited to, manufacturing, refining, and chemical production. Further, during the transformation of the raw materials into the finished goods a plurality of remains may be generated. Further, the plurality of remains may correspond to one or more gases. In some embodiments, when the plurality of remains exceed a predefined threshold, the industrial setting undergoes through a process that may be termed as flaring.

In some embodiments, the one or more flare stacks 104 may be configured to perform the flaring of the one or more gasses. Further, the flaring may refer to a process of controlled burning of excess one or more gases. In some embodiments, the one or more flare stacks 104 comprises one or more components (not shown) that may be configured to perform flaring of the one or more gases. Further, the one or more components may comprise a gas collection unit, flare header, knockout drum, flare tip, pilot burner, steam or air injection system, flame arrestor, and monitoring and control units. In some embodiments, the gas collection unit of the one or more flare stacks 104 may be configured to collect the excess one or more gases from various parts of a facility from the one or more facilities.

In some embodiments, the flare header of the one or more flare stacks 104 may correspond to a piping network that may be configured to transport the collected one or more gases from the gas collection unit to the one or more flare stacks 104. In some embodiments, the knockout drum of the one or more flare stacks 104 may be configured to remove any liquid constituents from the collected one or more gases to prevent liquid carryover into a flare. In some embodiments, the flare tip of the one or more flare stacks 104 may correspond to an end of the one or more flare stacks 104 when the one or more gases are ignited and burned.

In some embodiments, the pilot burner of the one or more flare stacks 104 may be configured to provide a continuous ignition source that facilitates a continuous burning of the one or more gases. In some embodiments, the steam or air injection system may be configured to provide additional oxygen or steam to the one or more flare stacks 104 during combustion of the one or more gases. In some embodiments, the flame arrestor of the one or more flare stacks 104 may be configured to prevent flashbacks of the flare generated during combustion of the one or more gases. In some embodiments, the monitoring and control units of the one or more flare stacks 104 may be configured to monitor operations of the one or more flare stacks 104 during flaring of the one or more gases.

Further, the monitoring and control units may comprise a temperature sensor, a pressure sensor, a flow rate sensor, etc. In some embodiments, the monitoring and control system may be configured to generate a flare data. Further, the flare data may correspond to mass or volume of gas flared within each of the one or more flare stacks 104, temperature of the gas flared, and pressure at which the gas is flared. In one example, the flow rate sensor may be configured to detect the mass or volume of the gas flared within each of the one or more flare stacks 104, the temperature sensor may be configured to detect the temperature of the gas flared, and the pressure sensor may be configured to detect the pressure at which the gas is flared.

In some embodiments, the server 106 may correspond to a computer or software module that is configured to provide centralized resources, data, or services to the one or more flare stacks 104. The server 106 may be configured to handle and manage one or more computational tasks and data processing within the system 100. In some embodiments, the server 106 may include storage systems, such as hard drives or storage arrays, to store and manage large volumes of data and information accessible to network users. In some embodiments, the server 106 may further provide centralized control and management capabilities, allowing network administrators to configure, monitor, and maintain network resources, security settings, and user access permissions from a single location.

In some embodiments, the server 106 may be configured to receive the flare data from the one or more flare stacks 104 in real time. Further, the flare data may correspond to mass or volume of gas flared within each of the one or more flare stacks 104, temperature of the gas flared, and pressure at which the gas is flared. In one example, the server 106 may be communicatively coupled with the monitoring and control system. Further, the server 106 may be configured to wirelessly receive the flare data from the monitoring and control system. For example, the flare data may comprise the mass or volume of gas flared within each of the one or more flare stacks 104 is 1000 cubic meters, the temperature of the gas flared is 850 degrees Celsius, and pressure at which the gas is flared is 60 psi.

In some embodiments, the server 106 may be configured to determine one or more peaks within the flare data using a machine learning (ML) model (not shown). In some embodiments, the one or more peaks within the flare data may correspond to a sudden deviation in the mass or volume of gas flared within each of the one or more flare stacks 104, temperature of the gas flared, and pressure at which the gas is flared. In some embodiments, the one or more peaks may comprise one or more parameters. Further, the one or more parameters of the one or more peaks may comprise at least one of start and stop time of the one or more peaks. In some embodiments, the ML model may comprise a plurality of machine learning (ML) algorithms. Further, the plurality of ML algorithms may be configured to assess the flare data received at the real time to determine the one or more peaks within the flare data.

In some embodiments, the server 106 may be configured to categorize the flare data of each of the one or more flare stacks 104 into a routine flaring and a non-routine flaring, based at least one the one or more determined peaks. Further, each of the one or more determined peaks may comprise the one or more parameters. Further, the server 106 may categorize the flare data into the routine flaring and the non-routine flaring using the ML model. Further, the routine flaring may refer to a regular and controlled burning of the one or more gases by the one or more flare stacks 104. Further, the routine flaring may correspond to a standard operational procedure that may facilitate management of the one or more gases within the one or more flare stacks 104.

In some embodiments, during the routine flaring, the one or more flare stacks 104 may be configured to burn/dispose a predefined volume of the one or more gases. In one example, the routine flaring is generally performed under stable conditions and manageable impacts on the environment. In some embodiments, the non-routine flaring may correspond to a response to unexpected operational issues that may include equipment malfunctions, power outages, or safety hazards. In some embodiments, the non-routine flaring may be conducted during unplanned or emergency situations. Further, during the non-routine flaring, the one or more flare stacks 104 may be configured to immediately release and combust the one or more gases.

In some embodiments, the server 106 may be configured to predict one or more flare events within the flare data categorized in the routine flaring and the non-routine flaring. In some embodiments, the server 106 may predict the one or more flare events within the flare data, based at least on a historical data and a set of parameters. Further, the server 106 may be configured to predict the one or more flare events using the ML model. In some embodiments, the historical data associated with the flare may comprise at least one of operational logs, equipment performance data, environmental conditions, incident reports, production data, and regulatory compliance records. Further, the set of parameters may comprise at least one of temperature and pressure of one or more components associated with each of the one or more flare stacks 104, control data, economics data, or compliance data. Further, the one or more flare events may correspond to one or more peaks in flaring. In some embodiments, the one or more peaks may represent a sudden increase in the flare data received by the server.

In some embodiments, the server 106 may be configured to determine one or more parameter setpoints and advisory information associated with the predicted one or more flare events. In some embodiments, the one or more parameter setpoints may comprise at least one of change in upstream vessels of the one or more flare stacks 104, change in temperature of upstream vessels of the one or more flare stacks 104, or change in speed of rotating machinery of the one or more flare stacks 104. In some embodiments, the advisory information may correspond to guidance and recommendations for an operation of each of the one or more flare stacks 104. Further, the server 106 may be configured to determine the advisory information based at least on compliance and economics of each of the one or more flare stacks 104. In some embodiments, the server 106 may provide the advisory information to eliminate or minimize non-routine flaring.

In some embodiments, the server 106 may be configured to deploy the determined one or more parameter setpoints and the advisory information on each of the one or more flare stacks 104, to manage the flaring. In one example, the server 106 may be configured to deploy the one or more parameter setpoints and the advisory information into the control and monitoring system of the one or more flare stacks 104. Further, the control and monitoring system of the one or more flare stacks 104 to adjust operations of the one or more components of the one or more flare stacks 104 in accordance to the one or more parameter setpoints and the advisory information. For example, adjustments of temperature and pressure of the one or more components associated with each of the one or more flare stacks 104.

In some embodiments, the server 106 may be configured to generate one or more alerts corresponding to the one or more parameter setpoints and the advisory information for the user. In some embodiments, the one or more alerts may comprise at least one of visual alerts, auditory alerts, textual alerts, tactile alerts, or remote alerts. In one example, the one or more facilities may comprise a display unit (not shown). Further, the display unit may be provided with an intrusive interface that may facilitate providing of the visual alerts to notify the user regarding the one or more parameter setpoints and the advisory information. In another example, the one or more facilities may comprise an alarming unit (not shown). Further, the alarming unit may be configured to generate the auditory alerts to notify the user regarding the one or more parameter setpoints and the advisory information.

In some embodiments, the system 100 may comprise the user device 108. Further, the user device 108 may be communicatively coupled to the one or more flare stacks 104 through the network 102. In one example, the user device 108 may be configured to display the one or more alerts associated with the one or more parameter setpoints and the advisory information for the one or more flare stacks 104. In some embodiments, the user device 108 may be configured to provide a real-time insight into working and status of each component of the one or more components of the one or more flare stacks 104. Further, the user device 108 may comprise at least one of a mobile phone, tablet, laptop, etc. In some embodiments, the user device 108 may be installed with a user interface (UI) or an application programmable interface (API) that may display the one or more alerts in a readable format that may facilitate the user to take an appropriate action in response to the one or more parameter setpoints and the advisory information for the one or more flare stacks 104.

It will be apparent to one skilled in the art that above-mentioned components of the system 100 have been provided only for illustration purposes, without departing from the scope of the disclosure.

FIG. 2 illustrates a block diagram of the server 106 of the system 100, in accordance with an example embodiment of the present disclosure. FIG. 2 is described in conjunction with FIG. 1.

In some embodiments, the server 106 may comprise at least one processor 200, a memory 202, a machine learning (ML) model 204, an input/output circuitry 206, and a communication circuitry 208. In some embodiments, the at least one processor 200 may include suitable logic, circuitry, and/or interfaces that are operable to execute one or more instructions stored in the memory 202 to perform predetermined operations. In one embodiment, the at least one processor 200 may be configured to decode the one or more instructions and execute the one or more instructions that are stored within the memory 202. The at least one processor 200 may be configured to execute one or more computer-readable program instructions, such as program instructions to carry out any of the functions described in this description. Further, the at least one processor 200 may be implemented using one or more processor technologies known in the art such as central processing unit (CPU), field-programmable gate array (FPGA), digital signal processors (DSP), etc. Examples of the at least one processor 200 may comprise at least one of, one or more general purpose processors and/or one or more special purpose processors that may be designed to handle the one or more flare stacks.

In some embodiments, the at least one processor 200 may be configured to receive the flare data from the one or more flare stacks 104 in real time. Further, the at least one processor 200 may be communicatively coupled with the control and monitoring system of the one or more flare stacks 104 to receive the flare data. In some embodiments, the flare data may correspond to the mass or volume of gas flared within each of the one or more flare stacks 104, temperature of the gas flared, and pressure at which the gas is flared. For example, the mass or volume of gas flared within each of the one or more flare stacks 104 is 800 cubic meters, temperature of the gas flared is 1300 degrees Celsius, and pressure at which the gas is flared is 80 psi. In one example, the at least one processor 200 is configured to receive the flare data from one or more sensors of the one or more flare stacks 104. Further, the one or more sensors may comprise a flow rate sensor, a temperature sensor, and a pressure sensor.

In some embodiments, the at least one processor 200 may be configured to determine the one or more peaks within the flare data. In some embodiments, the one or more peaks may correspond to a sudden increase in the flare data with a specific time period. In some embodiments, the one or more peaks may comprise the one or more parameters. Further, the one or more parameters of the one or more peaks may comprise at least one of the start and stop time of the one or more peaks. For example, a peak in the flare data may be determined by the at least one processor 200 during a component failure in the one or more flare stacks 104. The at least one processor 200 records a constant trend within the flare data and within a span of five minutes a sudden spike in the mass or volume of gas flared within each of the one or more flare stacks 104 is determined by the at least one processor 200. Further, the sudden spike may represent shifting of the mass or volume of gas flared from 500 cubic meter per hour to 1500 cubic meter per hour.

In some embodiments, the at least one processor 200 may be configured to determine the one or more peaks using the ML model 204. In some embodiments, the ML model 204 may be configured to work through a plurality of steps to cause the at least one processor 200 to determine the one or more peaks. In some embodiments, the plurality of steps may include but not limited to data collection, data preprocessing, feature extraction, model training, and peak detection. In some embodiments, during the data collection step, the at least one processor 200 to receive the flare data from the one or more flare stacks 104. Further, the at least one processor 200 may be configured to collect the flare data over a predefined period time. Further, the at least one processor 200 may be configured to preprocess the flare data. Further, during the preprocessing step, the at least one processor 200 may be configured to filter unwanted noise and irrelevant information from the flare data to prepare one or more datasets from the flare data. Further, during the preprocessing step, the at least one processor 200 may be configured to scale the flare data into a uniform range to eliminate inconsistency from the flare data. In some embodiments, the at least one processor 200 may be configured to perform the feature extraction step. Further, during the feature extraction step, the at least one processor 200 may be configured to transform the flare data into a structured format that may be suitable for the ML model 204.

In some embodiments, the at least one processor 200 may be configured to train the ML model 204 using the flare data to recognize patterns. Further, the at least one processor 200 may be configured to determine the one or more peaks within the flare data using the ML model 204. In some embodiments, the at least one processor 200 may be configured to involve one or more ML algorithms to train the ML model 204 to determine the one or more peaks. Further, the one or more ML algorithms may include but not limited to linear regression, decision trees, random forest, support vector machines (SVMs), neural networks, and gradient boosting machines (GBM). In some embodiments, the training process of the ML model 204 involve selection of an appropriate ML algorithm. In some embodiments, upon selecting the appropriate ML model 204, the at least one processor 200 may be configured to split the one or more datasets “i.e. the flare data” into a training dataset and a testing dataset. Further, the training dataset may be utilized to train the ML model 204, and the testing dataset may be utilized to test the trained ML model 204.

In some embodiments, once the trained ML model 204 may cause the at least one processor 200 to determine the one or more peaks by analyzing the real-time flare data. Further, the ML model 204 may cause the at least one processor 200 to monitor the flare data received in real time and compare the flare data with a learned pattern of the flare data using the appropriate ML algorithm. In some embodiments, the ML model 204 may cause the at least one processor 200 to identify one or more deviations or anomalies within the flare data, based at least on the comparison. Further, the one or more deviations or anomalies within the flare data may correspond to the one or more peaks within the flare data. Further, the one or more peaks may have the one or more parameters. Further, the one or more parameters of the one or more peaks may comprise at least one of the start and stop time of the one or more peaks. For example, the start time of a peak-1 from the one or more peaks is 4:50 pm and the stop time of the peak-1 from the one or more peaks is 5:15 pm. Further, the start time of a peak-2 from the one or more peaks is 5:30 pm and the stop time of the peak-2 from the one or more peaks is 5:52 pm.

In some embodiments, the at least one processor 200 may be configured to categorize the flare data of each of the one or more flare stacks 104 into the routine flaring and the non-routine flaring. Further, the at least one processor 200 may be configured to utilize the determined one or more peaks and the ML model 204 to categorize the flare data of each of the one or more flare stacks 104 into the routine flaring and the non-routine flaring. In some embodiments, the trained ML model 204 may be configured to recognize and analyze one or more patterns associated with the one or more peaks in the flare data. Further, the trained ML model 204 may be configured to determine whether the one or more patterns correspond to the routine flaring or non-routine flaring. Further, the ML model 204 may consider the one or more parameters of the one or more peaks. Further, the one or more parameters may include but not limited to the start and stop time of the one or more peaks in the flare data, frequency of the one or more peaks, and intensity of the one or more peaks in the flare data. In some embodiments, the at least one processor 200 may be configured to categorize the flare data of each of the one or more flare stacks 104 into the routine flaring and the non-routine flaring, based at least on the analysis of the one or more patterns.

For example, a refinery comprises a plurality of flare stacks, each generating a continuous stream of the flare data. The trained ML model 204 detects a peak in the flare data indicating a sudden increase in the flaring of the gas. In one instance, when the detected peak related with a scheduled maintenance operation or other known routine activities, then the at least one processor 200 categorizes the detected peak as a routine flaring. In another instance, when the detected peak does not align with the scheduled activities and indicates unusual change in the one or more parameters (e.g., a higher intensity, a longer duration between the start and stop time of the detected peak, or occurrence during normal operations), then the at least one processor 200 categorizes the detected peak as the non-routine flaring.

In some embodiments, the at least one processor 200 may be configured to predict the one or more flare events within the flare data that may be categorized in the routine flaring and the non-routine flaring, based at least on the historical data and the set of parameters (i.e. temperature and pressure of one or more components associated with each of the one or more flare stacks 104, control data, economics data, or compliance data). Further, the at least one processor 200 may utilize the ML model 204 to predict the one or more flare events. In some embodiments, the one or more flare events may correspond to the one or more peaks in the flare data. In some embodiments, the at least one processor 200 may be configured to analyze the historical data. Further, the historical data may comprise the flare data associated with previously recorded one or more peaks such as, frequency of the one or more peaks, start and stop time of the one or more peaks, intensity of the one or more peaks. Further, based at least on the historical data, the at least one processor 200 may be configured to train the ML model 204 to predict the one or more flare events.

In some embodiments, the at least one processor 200 may be configured to train the ML model 204 using the flare data of the previously detected one or more peaks. Further, during the training phase of the ML model 204, the ML model 204 may cause the at least one processor 200 to learn to recognize one or more patterns and correlation with the previously detected one or more peaks. Further, the ML model 204 may cause the at least one processor 200 to adjust its internal parameters to minimize prediction errors during the training phase. In some embodiments, once the ML model 204 is trained, the at least one processor 200 may predict the one or more flare events by correlating the flare data with one or more patterns learned by the trained ML model 204.

For example, a petrochemical plant having one or more flare stacks 104 that provides the flare data. The ML model 204 is trained on a historical data associated with the previously detected routine flaring (i.e. routine maintenance schedules) and non-routine flaring (past incidents of equipment malfunctions). Further, the ML model 204 is trained to categorize one or more specific patterns of the routine flaring and the non-routine flaring. In one instance, the trained ML model 204 detects a gradual increase in pressure and flow rate that matches the one or more patterns generated during past maintenance activities, the at least one processor 200 predicts a routine flaring scheduled to occur within next few hours. In another instance, the trained ML detects a sudden spike in the temperature and an unexpected fluctuation in gas composition that matches the one or more patterns generated during past equipment malfunctions, the at least one processor 200 predicts a non-routine flaring.

In some embodiments, the at least one processor 200 may be configured to determine one or more defective components from the one or more components associated with each of the one or more flare stacks 104, based at least on the prediction. In some embodiments, the one or more flare stacks 104 may comprise the one or more components such as a gas collection unit, flare header, knockout drum, flare tip, pilot burner, steam or air injection system, flame arrestor, and monitoring and control units. Further, the at least one processor 200 may be configured to determine patterns of recurrent issues or anomalies associated with the one or more components during the non-routine flaring. Further, the at least one processor 200 may be configured to determine the patterns of recurrent issues or anomalies associated with one or more components, based at least on the historical data and the prediction of the routine flaring and the non-routine flaring.

In some embodiments, the at least one processor 200 may be configured to determine the one or more parameter setpoints and the advisory information associated with the predicted one or more flare events. Further, the one or more parameter setpoints may comprise at least one of change in pressure of upstream vessels of the one or more flare stacks 104, change in temperature of upstream vessels of the one or more flare stacks 104, or change in speed of rotating machinery of the one or more flare stacks 104. In some embodiments, the at least one processor 200 may determine the change in pressure of upstream vessels of the one or more flare stacks 104 may indicate adjustment of a flow of the gas to the one or more flare stacks 104 that may prevent conditions leading to routine flaring or non-routine flaring. In some embodiments, the at least one processor 200 may determine the adjustment in temperature in the upstream vessels of the one or more flare stacks 104 may avoid influence of the temperature on chemical reactions and physical states of materials being processes that may reduce conditions leading to routine flaring or non-routine flaring. In some embodiments, the at least one processor 200 may determine the change in speed of rotating machinery of the one or more flare stacks 104 such as pumps, compressors, etc. may optimize flow rates and pressures, preventing a risk of the non-routine flaring. Further, the advisory information may correspond to guidance and recommendations for an operation of each of the one or more flare stacks 104 based at least on compliance and economics of each of the one or more flare stacks 104, to eliminate or minimize the non-routine flaring.

For example, a chemical plant where the ML model 204 predicts a non-routine flaring due to a sudden increase in pressure spike in an upstream vessel. The at least one processor 200 determine one or more parameter setpoints such as pressure adjustment, temperature control, and machinery speed. The at least one processor 200 may recommend lowering pressure in the upstream vessel to a specific parameter setpoint to reduce the flow rate to the one or more flare stacks 104. The at least one processor 200 suggests to increase temperature in another upstream vessel to enhance a processing efficiency and stabilize the one or more flare stacks 104.

In some embodiments, the at least one processor 200 may be configured to deploy the determined one or more parameter setpoints and the advisory information on each of the one or more flare stacks 104, to manage the flaring. In one example, the at least one processor 200 may be configured to deploy the one or more parameter setpoints and the advisory information into the control and monitoring system of the one or more flare stacks 104. Further, the control and monitoring system of the one or more flare stacks 104 to adjust operations of the one or more components of the one or more flare stacks 104 in accordance to the one or more parameter setpoints and the advisory information. For example, adjustments of temperature and pressure of the one or more components associated with each of the one or more flare stacks 104. In some embodiments, the at least one processor 200 may be configured to generate the one or more alerts corresponding to the one or more parameter setpoints, the advisory information, and the one or more defective components for the user. In some embodiments, the one or more alerts may comprise at least one of visual alerts, auditory alerts, textual alerts, tactile alerts, or remote alerts.

In some embodiments, the memory 202 may be configured to store a set of instructions and data executed by the at least one processor 200. Further, the memory 202 may include the one or more instructions that are executable by the at least one processor 200 to perform specific operations. The memory 202 may be configured to include the instructions to receive the flare data from the one or more flare stacks 104 in real time. The memory 202 may be configured to include the instructions to determine the one or more peaks within the flare data, using the machine learning (ML) model 204. Further, the memory 202 may be configured to include the instructions to categorize the flare data of each of the one or more flare stacks 104 into the routine flaring and the non-routine flaring, based at least on the one or more determined peaks having the one or more parameters, using the ML model 204. The memory 202 may be configured to include the instructions to predict one or more flare events within the flare data categorized in the routine flaring and the non-routine flaring, based at least on the historical data and the set of parameters, using the ML model 204. Further, the memory 202 may be configured to include the instructions to determine one or more parameter setpoints and advisory information associated with the predicted one or more flare events. Thereafter, the memory 202 may be configured to include the instructions to deploy the determined one or more parameter setpoints and the advisory information on each of the one or more flare stacks 104, to manage the flaring.

The memory 202 may be configured to store the flare data of the one or more components of the one or more flare stacks 104. It is apparent to a person with ordinary skill in the art that the one or more instructions stored in the memory 202 enable the hardware of the system 100 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the server 106 may further comprise the input/output circuitry 206. The input/output circuitry 206 may enable the user to communicate or interface with the system 100, via the user device 108. The user device 108 may include N number of user devices. In some embodiments, the input/output circuitry 206 may act as a medium to transmit input from the one or more flare stacks 104 to and from the system 100. In some embodiments, the input/output circuitry 206 may refer to the hardware and software components that facilitate the exchange of information between the user device 108 and the server 106. In one example, the server 106 may include the user interface as input circuitry that facilitates monitoring of the data of the one or more components of the one or more flare stacks 104. The input/output circuitry 206 may include various input devices such as the one or more components of the one or more flare stacks 104 and various output devices such as the user device 108, printers for the one or more users to receive data.

In some embodiments, the server 106 may further comprise the communication circuitry 208. The communication circuitry 208 may allow the server 106 to exchange data or information with the user device 108, other systems or apparatuses. Further, the communication circuitry 208 may include network interfaces, protocols, and software modules responsible for sending and receiving data or information from the user device 108. In some embodiments, the communication circuitry 208 may include Ethernet ports, Wi-Fi adapters, or communication protocols like HTTP or MQTT for connecting with other systems. The communication circuitry 208 may further include components such as communication modules (e.g., Wi-Fi, Ethernet, cellular), transceivers, antennas, and protocols (e.g., TCP/IP, MQTT, SNMP) for exchanging data with the user device 108 and the other systems. The communication circuitry 208 may allow the server 106 to stay up-to-date.

It will be apparent to one skilled in the art the above-mentioned components of the server 106 have been provided only for illustration purposes, without departing from the scope of the disclosure.

FIG. 3 illustrates a block diagram showing different stages of the system 100 for managing the flaring in accordance with an example embodiment of the present disclosure.

At stage-1 300, the at least one processor 200 may be configured to determine operational visibility of the one or more flare stacks 104. In one example, the at least one processor 200 may be configured to determine the operational visibility of the one or more flare stacks 104 using one or more sensors such as temperature sensor, pressure sensor, and flow rate sensor. In some embodiments, the at least one processor 200 may be configured to receive the flare data from the one or more flare stacks 104, upon determining the operational visibility of the one or more flare stacks 104. In some embodiments, the at least one processor 200 may be configured to determine operational visibility of the one or more flare stacks 104, based at least on the flare data. In some embodiments, the flare data may correspond to a flaring induced emission calculation and visualization of the one or more flare stacks 104. In some embodiments, the flare data may be detected by the monitoring and control system of the one or more flare stacks 104. Further, the monitoring and control units may comprise a temperature sensor, a pressure sensor, a flow rate sensor, etc. In some embodiments, the monitoring and control system may be configured to generate the flare data.

At stage-2 302, the at least one processor 200 may be configured to detect at least one flaring event, classify the at least one flaring event, and contextualize the at least one flaring event. The at least one processor 200 may be configured to detect the one or more peaks within the flare data using the ML model 204. In some embodiments, the one or more peaks within the flare data may correspond to a sudden deviation in the mass or volume of gas flared within each of the one or more flare stacks 104, temperature of the gas flared, and pressure at which the gas is flared. In some embodiments, the ML model 204 may comprise the plurality of machine learning (ML) algorithms. Further, the plurality of ML algorithms of the ML model 204 may cause the at least one processor 200 to assess the flare data received at the real time to determine the one or more peaks within the flare data. In some embodiments, the at least one processor 200 may be configured to categorize the flare data of each of the one or more flare stacks 104 into the routine flaring and the non-routine flaring, based at least one the one or more determined peaks.

Further, each of the one or more determined peaks may comprise the one or more parameters. Further, the at least one processor 200 may categorize the flare data into the routine flaring and the non-routine flaring using the ML model 204. Further, the routine flaring may refer to a regular and controlled burning of the one or more gases by the one or more flare stacks 104. Further, the routine flaring may correspond to a standard operational procedure that may facilitate management of the one or more gases within the one or more flare stacks 104. In some embodiments, during the routine flaring, the one or more flare stacks 104 may be configured to burn/dispose a predefined volume of the one or more gases. In some embodiments, the system 100 may be implemented into the one or more flare stacks 104 to minimize or eliminate the routine flaring of the one or more flare stacks 104. In some embodiments, the non-routine flaring may correspond to a response to unexpected operational issues that may include equipment malfunctions, power outages, or safety hazards.

At stage-3 304, the at least one processor 200 may be configured to predict one or more flare events within the flare data categorized in the routine flaring and the non-routine flaring. In some embodiments, the at least one processor 200 may be configured to perform a root cause analysis (RCA) on the flare data using the ML model 204 to predict the one or more flare events within the flare data, based at least on the historical data and the set of parameters. As illustrated in FIG. 3, the at least one processor 200 may be configured to combine a small and medium-sized enterprises (SME) data, historian data (i.e. historical data), and control data (i.e. the flare data). In one example, the at least one processor 200 may utilize one or more artificial intelligence (AI) protocols to predict the one or more flare events. In another example, the at least one processor 200 may be configured to predict the one or more flare events using the ML model 204. In some embodiments, the set of parameters may comprise the compliance data (“smoking”, “efficiency”, “net heating value of combustion zone (NHVcz)”), the economics data (“fuel and steam utilization”), and a proper data (“backburn”, “coking”).

In some embodiments, the at least one processor 200 may be configured to analyze the historical data. Further, the historical data may comprise the flare data associated with previously recorded one or more peaks such as, frequency of the one or more peaks, start and stop time of the one or more peaks, intensity of the one or more peaks. Further, based at least one the historical data, the at least one processor 200 may be configured to train the ML model 204 to predict the one or more flare events. In one example, the at least one processor 200 may be configured to utilize the compliance data, the economics data, and the proper data to predict the one or more peaks. In some embodiments, the compliance data may ensure the predicted one or more peaks adheres to regulatory standards. Further, the economics data may ensure an optimal use of resources. Further, the operational data may provide insights into practical aspects of the flare data.

At stage-4 306, the at least one processor 200 may be configured to determine the one or more parameter setpoints and advisory information to optimize the one or more flare stacks 104. In some embodiments, the at least one processor 200 may be configured to provide the one or more parameter setpoints to avoid routine flaring. In some embodiments, the one or more parameter setpoints may comprise at least one of change in upstream vessels of the one or more flare stacks 104, change in temperature of upstream vessels of the one or more flare stacks 104, or change in speed of rotating machinery of the one or more flare stacks 104. In some embodiments, the at least one processor 200 may be configured to provide the one or more parameter setpoints to flare properly, based at least on the compliance data, economics data, and equipment design to prevent the non-routine flaring.

At stage-5 308, the at least one processor 200 may be configured to autonomously control operation of the one or more flare stacks 104. In some embodiments, the trained ML model 204 may be deployed to the one or more flare stacks 104 to directly predict, optimize, and enter the one or more parameter setpoints in the one or more flare stacks 104. In some embodiments, the at least one processor 200 may be configured to receive the flare data from the one or more flare stacks 104. Further, the trained ML model 204 may facilitate the at least one processor 200 to predict potential flare events, based at least on the learning data, historical data, and a real-time data. Further, the trained ML model 204 may be configured to autonomously determine the one or more parameter setpoints to optimize operations of the one or more flare stacks 104.

FIG. 4 illustrates a detailed flowchart showing a method 400 for managing the flaring within one or more flare stacks 104 using the ML model 204, in accordance with an example embodiment of the present disclosure.

At operation 402, the at least one processor 200 may be configured to receive the flare data from the one or more flare stacks 104 in real time from the one or more flare stacks 104. Further, the flare data may comprise mass or volume of gas flared within each of the one or more flare stacks 104, temperature of the gas flared, and pressure at which the gas is flared. For example, the flare data may comprise the mass or volume of gas flared within each of the one or more flare stacks 104 is 1200 cubic meters, the temperature of the gas flared is 600 degrees Celsius, and pressure at which the gas is flared is 40 psi.

At operation 404, the at least one processor 200 may be configured to determine the one or more peaks within the flare data using the machine learning (ML) model 204. In some embodiments, the one or more peaks within the flare data may correspond to a sudden deviation in the mass or volume of gas flared within each of the one or more flare stacks 104, temperature of the gas flared, and pressure at which the gas is flared. In some embodiments, the ML model 204 may comprise a plurality of machine learning (ML) algorithms. In some embodiments, the plurality of ML algorithms may comprise at least one of a random forest, density-based spatial clustering of applications with noise (DBSCAN). Further, the plurality of ML algorithms may be configured to assess the flare data received at the real time to determine the one or more peaks within the flare data.

At operation 406, the one or more peaks may comprise one or more parameters. Further, the one or more parameters comprise at least one of start and stop time of the one or more peaks. For example, the at least one processor 200 detects 4 peaks (peak-1, peak-2, peak-3, and peak-4) from the flare data, the start time of the peak-1 is 3:00 am and the stop time of the peak-1 is 3:15 am, the start time of the peak-2 is 3:40 am and the stop time of the peak-2 is 3:55 am, the start time of the peak-3 is 4:05 am and the stop time of the peak-3 is 4:15 am, and the start time of the peak-4 is 4:30 am and the stop time of the peak-4 is 4:43 am.

At operation 408, the at least one processor 200 may be configured to categorize the flare data of each of the one or more flare stacks 104 into the routine flaring and the non-routine flaring (i.e. safety/emergency), based at least one the one or more determined peaks. Further, the at least one processor 200 may categorize the flare data into the routine flaring and the non-routine flaring using the ML model 204. In some embodiments, the at least one processor 200 may be configured to train the ML model 204 based at least on the flare data received in real time. Further, the trained ML model 204 may be configured to categorize the one or more peaks from the flare data into the routine flaring or the non-routine flaring, based at least on one or more peaks from one or more patterns of the previously detected one or more peaks.

In some embodiments, the at least one processor 200 may be configured to utilize the ML model 204 to categorize the flare data of each of the one or more flare stacks 104 into the routine flaring and the non-routine flaring. In some embodiments, the at least one processor 200 may categorize the one or more peaks by correlating the flare data with the one or more patterns learned by the ML model 204 during training. In some embodiments, the one or more patterns may correspond to one or more flare data provided by the one or more flare stacks 104 during different conditions such as component failures, routine maintenance procedure, etc.

At operation 410, the at least one processor 200 may be configured to categorize the flare data (i.e. mass or volume of the gas flared) per hour/day of the one or more flare stacks 104. In some embodiments, the at least one processor 200 may be configured to categorize the flare data received during the routine flaring as flare data-1. Further, the at least one processor 200 may be configured to categorize the flare data received during the non-routine flaring as flare data-2. In one example, the flare data-1 comprise the mass or volume of gas flared within each of the one or more flare stacks 104—1000 cubic meters, the temperature of the gas flared-850 degrees Celsius, and pressure at which the gas is flared-60 psi. In another example, the flare data-2 comprise the mass or volume of gas flared within each of the one or more flare stacks 104—1500 cubic meters, the temperature of the gas flared-1130 degrees Celsius, and pressure at which the gas is flared-90 psi.

At operation 412, the at least one processor 200 may be configured to predict the one or more flare events within the flare data categorized in the routine flaring. In some embodiments, the at least one processor 200 may predict the one or more flare events within the flare data, based at least on the historical data and the set of parameters. Further, the at least one processor 200 may be configured to predict the one or more flare events using the ML model 204. In some embodiments, the at least one processor 200 may be configured to determine one or more defective components from the one or more components of the one or more flare stacks 104. At operation 414, the at least one processor 200 may be configured to predict the one or more peaks within the flare data categorized in the routine flaring and the non-routine flaring. In some embodiments, the ML model 204 may cause the at least one processor 200 to utilize at least one ML algorithm to predict the one or more peaks in the flare data.

In some embodiments, the at least one processor 200 may be configured to analyze the historical data and the learned data using the ML model 204. Further, the historical data and the learned data may comprise the flare data associated with previously recorded one or more flare events Further, based at least one the historical data, the at least one processor 200 may be configured to train the ML model 204 to predict the one or more flare events. In one example, the at least one processor 200 may be configured to utilize the compliance data, the economics data, and the proper data to predict the one or more peaks.

At operation 416, the at least one processor 200 may be configured to analyze root cause for the routine flaring of the one or more flare stacks 104. In some embodiments, the at least one processor 200 may be configured to analyze the flare data (i.e., pressure of the gas being flared, and temperature of the gas flared). In some embodiments, the at least one processor 200 may be configured to perform the root cause analysis using the historical data received from the trained ML model 204.

At operation 418, the at least one processor 200 may be configured to predict the one or more flare events within the flare data of the non-routine flaring, based at least on the historical data and the set of parameters. Further, the at least one processor 200 may be configured to predict the one or more flare events using the ML model 204. In some embodiments, the historical data associated with the flare may comprise at least one of operational logs, equipment performance data, environmental conditions, incident reports, production data, and regulatory compliance records. In some embodiments, the set of parameters may comprise at least one of a compliance data, economics data, etc. to optimize efficiency of the one or more flare stacks 104.

At operation 420, the at least one processor 200 may be configured to determine advisory information associated with the predicted one or more flare events of the routine flaring. In some embodiments, the at least one processor 200 utilize root cause analysis to provide advisory information to prevent routine flaring. In some embodiments, the advisory information to prevent routine flaring may comprise maintenance advice to eliminate routine flaring. In some embodiments, the at least one processor 200 may be configured to determine the one or more parameter setpoints associated with the predicted one or more flare events. In some embodiments, the one or more parameter setpoints may comprise at least one of change in upstream vessels of the one or more flare stacks 104, change in temperature of upstream vessels of the one or more flare stacks 104, or change in speed of rotating machinery of the one or more flare stacks 104.

At operation 422, the at least one processor 200 may be configured to determine the advisory information associated with the non-routine flaring. Further, the at least one processor 200 may be configured to provide advisory information that may comprise how to reduce the non-routine flaring based on compliance data (flare efficiency, smoking, etc.), economics (using air and steam to assist in flaring), etc.

At operation 424, the at least one processor 200 may be configured to determined results of the root cause analysis associated with the routine flaring and the non-routine flaring. Further, the at least one processor 200 may be configured to provide data associated with efficiency of the one or more flare stacks 104. In some embodiments, the at least one processor 200 may be configured to provide data on effect of steam/air assistance on efficiency of the one or more flare stacks 104. In some embodiments, the at least one processor 200 may be configured to deploy the one or more parameter setpoints and the advisory information into the one or more flare stacks 104. Further, the at least one processor 200 may be configured to determine efficiency data of the one or more flare stacks 104 after deployment of the one or more parameter setpoints into the one or more flare stacks 104.

At operation 426, the at least one processor 200 may be configured to autonomously control operation of the one or more flare stacks 104 using the ML model 204. In some embodiments, the ML model 204 may cause the at least one processor 200 to utilize the historical data to prevent routine flaring. In some embodiments, the at least one processor 200 may be configured to adjust operations of the one or more components of the one or more flare stacks 104, based at least one or more parameter setpoints and the historical data (e.g. by automating the change of features that are controllable). In some embodiments, the ML model 204 may cause the at least one processor 200 to utilize the historical data to prevent non-routine flaring. In some embodiments, the at least one processor 200 may be configured to adjust operations of the one or more components of the one or more flare stacks 104, based at least on one or more parameter setpoints and the historical data (e.g. prevent reactor shutdowns).

FIG. 5 illustrates a block diagram showing one or more conditions that lead to a routine flaring 500, in accordance with an example embodiment of the present disclosure. FIG. 5 is described in conjunction with FIG. 4.

In some embodiments, the at least one processor 200 may be configured to train the ML model 204 using the flare data to recognize patterns. Further, the patterns may correspond to the flare data received from the one or more flare stacks 104 during one or more conditions. In some embodiments, the one or more conditions may lead to the routine flaring 500. In some embodiments, the routine flaring 500 may refer to a regular and controlled burning of the one or more gases by the one or more flare stacks 104. Further, the routine flaring 500 may correspond to a standard operational procedure that may facilitate management of the one or more gases within the one or more flare stacks 104. In some embodiments, during the routine flaring 500, the one or more flare stacks 104 may be configured to burn/dispose a predefined volume of the one or more gases. In some embodiments, the one or more conditions that may lead to the routine flaring 500 may comprise economic factors 502, an operational safety 504, production balancing 506, and technical limitation 508. In some embodiments, each of the one or more conditions may provide a different flare data that may be utilized by the at least one processor to train the ML model 204. In some embodiments, the economic factors 502 that may lead to the routine flaring 500 may comprise a cost of recovery. In some scenarios, a cost of capturing and processing an excess amount of gases is higher that an economic return from selling or using them, thereby the routine flaring 500 may be performed to eliminate the excess amount of the gases from the one or more flare stacks 104. In some embodiments, the economic factors 502 that may lead to the routine flaring 500 may further comprise the market conditions. In some instances, processing of certain gases is economically unfeasible, that may indicate the one or more flare stacks 104 to perform the routine flaring 500 to eliminate such gases.

In some embodiments, the operational safety 504 involves burning off the gas to prevent a dangerous pressure build-ups or release of hazardous substances. In some embodiments, during maintenance or unexpected shutdowns the routine flaring 500 is performed to ensure the operational safety 504. Further, the routine flaring 500 may ensure that such gases may be combusted in a controlled way, such that a risk of explosions, fires, or safety incidents may be prevented. In some embodiments, the routine flaring 500 may be performed to manage the production balancing 506 by managing productions rates and ensure that the one or more components of a processing unit may operate within optimal parameters. In some embodiments, the technical limitation 508 associated with the processing plants may lead to routine flaring 500. In some embodiments, the routine flaring 500 may be performed due to lack of capacity to capture, store, or utilize all the gases produced during operations of such processing plants.

FIG. 6 illustrates a block diagram showing one or more component failures that lead to a non-routine flaring 600 in accordance with an example embodiment of the present disclosure.

In some embodiments, the at least one processor 200 may be configured to train the ML model 204 using the flare data to recognize patterns associated with the non-routine flaring 600. Further, the patterns may correspond to the flare data received from the one or more flare stacks 104 during one or more conditions. In some embodiments, the one or more conditions may correspond to component failures. In some embodiments, the one or more flare stacks 104 may be configured to perform the non-routine flaring 600 due to component failures. In some embodiments, the component failures may comprise at least one of a shaft failure 602, a compressor failure 604, a surging failure 606, and a motor failure 608. Further, the shaft failure 602 may occur when a rotating shaft within a machinery, such as a compressor or a pump, breaks or becomes misaligned. Further, the shaft failure 602 may lead to an abrupt halt in operations, causing an excess buildup of gases. Further, in such scenarios, the one or more flare stacks 104 may be configured to perform the non-routine flaring 600. Further, the compressor failure 604 may involve breakdown of equipment responsible for pressurizing gases, that may result in the inability to process or transport the gases. In such scenarios, the one or more flare stacks 104 may be configured to perform the non-routine flaring 600.

In some embodiments, the surging failure 606 may occur when there is an unstable flow within the compressor, leading to oscillations that may damage the equipment and disrupt gas processing. In such instances, the one or more flare stacks 104 may be configured to perform the non-routine flaring 600. Further, the motor failure 608 may involve malfunction of electric motors that drive various pieces of equipment. In instances when a motor fails, it may cause a cascade of operational issues, including the stoppage of pumps and compressors, leading to an accumulation of gases. In such scenarios, the one or more flare stacks 104 may be configured to perform the non-routine flaring 600. In some embodiments, the at least one processor 200 may be configured to train the ML model 204 to recognize the patterns associated with the non-routine flaring.

FIG. 7 illustrates an exemplary scenario of an industrial setting 700 having one or more flare stacks 104, in accordance with an example embodiment of the present disclosure. FIG. 8A illustrates a graphical representation 800 showing response of the system 100 for managing the flaring using the ML model 204, in accordance with an example embodiment of the present disclosure. FIG. 8B illustrates a table 804 having data related to the response of the system 100 for managing the flaring, in accordance with an example embodiment of the present disclosure. FIGS. 7-8B are described in conjunction with FIGS. 1-6.

In some embodiments, the industrial setting 700 may comprise the one or more flare stacks 104, the industrial plant distribution control system 702, a flare combustion control 704, an assist gas source 706, a fuel gas source 708, and a flare gas source 710. In some embodiments, the one or more flare stacks 104 are vertical pipes that may be configured to release and combust the excess gases. Further, a flame 712 on a top end of the one or more flare stacks 104 may indicate combustion of the gases. In some embodiments, the industrial plant distribution control system 702 may be configured to manage distribution of gases within the industrial setting 700. In some embodiments, the industrial plant distribution control system 702 may be configured to interface with the flare combustion control 704 to regulate the flaring based on real-time data. In some embodiments, the flare combustion control 704 may be configured to monitor and regulate a combustion process in the one or more flare stacks 104. Further, the flare combustion control 704 may be configured to adjust the one or more parameters such as flame stability, combustion temperature, and gas flow rates to ensure efficient and safe burning of gases.

In some embodiments, the assist gas source 706 may be configured to provide auxiliary gases (such as steam, air, or nitrogen) to enhance the flaring process. Further, the assist gases may help to achieve complete combustion, reducing smoke and emissions. In some embodiments, the fuel gas source 708 may be configured to supply a fuel gas to maintain a continuous pilot flame, ensuring the flare is always ready to ignite any flared gases. Further, the flare gas source 710 may be configured to supply the excess gases that need to be flared, originating from various process units within the industrial setting 700 (e.g., relief valves, blowdown systems, or emergency venting systems).

In one example, the excess gases may be directed from the flare gas source 710 into the one or more flares for combustion. Further, the flow rate and volume of the supplied gases may be managed by the industrial plant distribution control system 702. Further, the assist gases may be supplied into the one or more flare stacks 104 to support the combustion process. Further, the flow rate of assist gases may be controlled to ensure optimal mixing and efficient burning of the flare gases. Further, a continuous supply of fuel gas may be maintained to keep the pilot flame active. Further, the fuel gas may be configured to ensure that any incoming flare gases may be immediately ignited, preventing the release of unburned gases. Further, the flare combustion control 704, in conjunction with the industrial plant distribution control system 702, may be configured to monitor and adjust the entire process of the routine flare or the non-routine flaring 600.

As illustrated in FIG. 8A, the graphical representation 800 may represent response of the system 100 when implemented into the industrial setting 700. In some embodiments, the at least one processor 200 may be configured to determine one or more peaks 802 within the flare data provided by the one or more flare stacks 104 of the industrial setting 700, using the machine learning (ML) model 204. The graphical representation 800 may illustrate the one or more peaks 802 in the flare data of the one or more flare stacks 104. The x-axis of the graphical representation 800 may represent a time period. The y-axis of the graphical representation 800 may represent value of the one or more peaks 802 associated with the flare data. In one example, the value of the one or more peaks 802 represented by the y-axis may correspond to a temperature of the gas flared. In some embodiments, the one or more peaks 802 may be recorded on Jan. 1, 2023 with 580 degree Celsius, 26 Jan. 2023 with 380 degree Celsius, 23 Jan. 2030 with 430 degree Celsius, May 2, 2023 with 420 degree Celsius, Dec. 3, 2023 with 380 degree Celsius, 23 Mar. 2015 with 390 degree Celsius, Apr. 4, 2023 with 425 degree Celsius, 28 Apr. 2023 with 620 degree Celsius.

As illustrated in FIG. 8B, the table 804 comprises three columns, flare event 01/23-07/23—806, date 808, and a type of flare 810. Further, the first peak occurred on Jan. 1, 2023 with 580 points. Further, the at least one processor 200 may categorize the first peak as the non-routine flaring 600. Further, the second peak occurred on 26 Jan. 2023 with 380 points. Further, the at least one processor 200 may categorize the first peak as the routine flaring 500. Further, the third peak occurred on 30 Jan. 2023 with 430 points. Further, the at least one processor 200 may categorize the first peak as the non-routine flaring 600. Further, the fourth peak occurred on May 2, 2023 with 420 points. Further, the at least one processor 200 may categorize the first peak as the routine flaring 500. Further, the fifth peak occurred on Dec. 3, 2023 with 380 points. Further, the at least one processor 200 may categorize the first peak as the non-routine flaring 600. Further, the sixth peak occurred on 15 Mar. 2023 with 390 points. Further, the at least one processor 200 may categorize the first peak as the non-routine flaring 600. Further, the seventh peak occurred on Apr. 4, 2023 with 425 points. Further, the at least one processor 200 may categorize the first peak as the non-routine flaring 600.

FIG. 9 illustrates a flowchart showing a method 900 for managing the flaring using the ML model 204, in accordance with an example embodiment of the present disclosure.

At operation 902, the at least one processor 200 may be configured to receive the flare data from the one or more flare stacks 104 in real time. Further, the flare data may correspond to mass or volume of gas flared within each of the one or more flare stacks 104, temperature of the gas flared, and pressure at which the gas is flared.

For example, in a large oil refinery, one or more flare stacks 104 having a network of one or more components such as burners, ignition system, sensors, and control units. A system 100 for optimizing one or more flare stacks 104 is deployed. Further, at least one processor 200 associated with the system 100 is configured to receive flare data from a flare stack in a real time. The flare data includes a mass or volume of gas flared within the one or more flare stacks 104, temperature of the gas flared, and pressure at which the gas is flared. Further, the mass or volume of gas flared within the one or more flare stacks 104=1200 cubic meters, temperature of the gas flared=1150 degrees Celsius, and pressure at which the gas is flared=75 psi.

At operation 904, the at least one processor 200 may be configured to determine the one or more peaks 802 within the flare data using the machine learning (ML) model 204. In some embodiments, the one or more peaks 802 may correspond to a sudden increase in the flare data with a specific time period. In some embodiments, the one or more peaks 802 may comprise the one or more parameters. Further, the one or more parameters of the one or more peaks 802 may comprise at least one of the start and stop time of the one or more peaks 802.

For example, the at least one processor 200 determined a first flare event and a second flare event in the flare data using a machine learning (ML) model 204. Further, the first flare event started at 3:45 PM and ended at 4:25 PM. The second flare event started at 4:25 PM and ended at 4:45 PM. Further, during the first flare event, the pressure in an upstream vessel of the one or more flare stacks 104 increased from 50 psi to 85 psi. During the second flare event the pressure in an upstream vessel of the one or more flare stacks 104 increased from 55 psi to 80 psi. Further, the temperature in the upstream vessel rise from 350 degrees Celsius to 400 degrees Celsius during the first flare event and from 360 degrees Celsius to 410 degrees Celsius during the second flare event. Further, the ML model 204 detected that the speed of a rotating machinery “i.e. a compressor upstream of the one or more flare stacks 104” increased from 1,800 RPM to 2,200 RPM during the first flare event and from 1,850 RPM to 2,250 RPM during the second flare event.

At operation 906, the at least one processor 200 may be configured to categorize the flare data of each of the one or more flare stacks 104 into the routine flaring 500 and the non-routine flaring 600. Further, the at least one processor 200 may be configured to utilize the determined one or more peaks 802 and the ML model 204 to categorize the flare data of each of the one or more flare stacks 104 into the routine flaring 500 and the non-routine flaring 600. In some embodiments, the trained ML model 204 may be configured to recognize and analyze one or more patterns associated with the one or more peaks 802 in the flare data. Further, the trained ML model 204 may be configured to determine whether the one or more patterns correspond to the routine flaring 500 or non-routine flaring 600.

For example, the flare data is categorized by the at least one processor 200 as the first flare event, starting at 3:45 PM and ending at 4:25 PM, shows a first peak representing an increase in pressure from 50 psi to 85 psi, a temperature rise from 350 degrees Celsius to 400 degrees Celsius, and an increase in compressor speed from 1,800 RPM to 2,200 RPM. The second flare event starting at 4:25 PM and ending at 4:45 PM, shows a second peak representing an increase in pressure from 55 psi to 80 psi, a temperature rises from 360 degrees Celsius to 410 degrees Celsius, and an increase in compressor speed from 1,850 RPM to 2,250 RPM. Thereby, the at least one processor 200 categorizes, the flare data of the one or more flare stacks 104 into a non-routine flaring 600, based at least on the one or more parameters, using the ML model 204.

At operation 908, the at least one processor 200 may be configured to predict the one or more flare events within the flare data that may be categorized in the routine flaring 500 and the non-routine flaring 600, based at least on the historical data and the set of parameters (i.e. temperature and pressure of one or more components associated with each of the one or more flare stacks 104, control data, economics data, or compliance data). Further, the at least one processor 200 may utilize the ML model 204 to predict the one or more flare events. In some embodiments, the one or more flare events may correspond to the one or more peaks 802 in the flare data.

For example, the ML model 204 detects early signs of a potential peak. At 2:30 PM on the next day, it notices that the pressure in an upstream vessel is increasing from 45 psi to 70 psi over a short period. Simultaneously, the temperature in the upstream vessel starts rising from 340 degrees Celsius to 390 degrees Celsius, and the compressor speed begins to increase from 1,750 RPM to 2,150 RPM. Based on these parameters and the patterns learned from previous events, the ML model 204 predicts that a peak similar to the previous non-routine flaring 600 events might occur around 3:00 PM.

At operation 910, the at least one processor 200 may be configured to determine the one or more parameter setpoints and the advisory information associated with the predicted one or more flare events. Further, the one or more parameter setpoints may comprise at least one of change in pressure of upstream vessels of the one or more flare stacks 104, change in temperature of upstream vessels of the one or more flare stacks 104, or change in speed of rotating machinery of the one or more flare stacks 104.

For example, the at least one processor 200 is configured to determine one or more parameter setpoints and advisory information associated with the predicted one or more peaks 802 within the flare data for the non-routine flaring 600. Further, the one or more parameter setpoints includes an operational pressure range of 40 psi to 65 psi within the upstream vessel, an operational temperature range of 330 degree Celsius to 380 degree Celsius within the upstream vessel, and an operational speed range of 1700 rpm to 2100 rpm of the compressor. Further, the advisory information includes an advice on how to reduce the non-routine flaring 600 based on compliance (flare efficiency, smoking, etc.), economics (using air and steam to assist in flaring), etc.

At operation 912, the at least one processor 200 may be configured to deploy the determined one or more parameter setpoints and the advisory information on each of the one or more flare stacks 104, to manage the flaring. In one example, the at least one processor 200 may be configured to deploy the one or more parameter setpoints and the advisory information into the control and monitoring system of the one or more flare stacks 104. Further, the control and monitoring system of the one or more flare stacks 104 to adjust operations of the one or more components of the one or more flare stacks 104 in accordance to the one or more parameter setpoints and the advisory information.

For example, the at least one processor 200 is configured to deploy the determined one or more parameter setpoints and the advisory information on each of the one or more flare stacks 104 having the non-routine flaring 600, to optimize the one or more flare stacks 104. Further, the at least one processor 200 is configured to perform adjustments of temperature and pressure of the one or more components associated with each of the one or more flare stacks 104.

In some embodiments, a non-transitory machine-readable information storage medium is disclosed. The non-transitory machine-readable information storage medium may comprise one or more instructions which when executed by at least one processor 200 cause the at least one processor 200 to receive the flare data from the one or more flare stacks 104 in real time. The flare data may correspond to mass or volume of gas flared within each of the one or more flare stacks 104, temperature of the gas flared, and pressure at which the gas is flared. Further, the non-transitory machine-readable information storage medium may comprise one or more instructions which when executed by the at least one processor 200 cause the at least one processor 200 to determine the one or more peaks 802 within the flare data, using the machine learning (ML) model 204. The one or more peaks 802 having the one or more parameters that may comprise at least one of start and stop time of the one or more peaks 802. Further, the non-transitory machine-readable information storage medium may comprise one or more instructions which when executed by the at least one processor 200 cause the at least one processor 200 to categorize the flare data of each of the one or more flare stacks 104 into the routine flaring 500 and the non-routine flaring 600, based at least on the one or more determined peaks having the one or more parameters, using the ML model 204. Further, the non-transitory machine-readable information storage medium may comprise one or more instructions which when executed by the at least one processor 200 cause the at least one processor 200 to predict the one or more flare events within the flare data categorized in the routine flaring 500 and the non-routine flaring 600, based at least on the historical data and the set of parameters, using the ML model 204. The one or more flare events may correspond to the one or more peaks 802 in flaring. The set of parameters may comprise at least one of temperature and pressure of one or more components associated with each of the one or more flare stacks 104, control data, economics data, or compliance data.

Further, the non-transitory machine-readable information storage medium may comprise one or more instructions which when executed by the at least one processor 200 cause the at least one processor 200 to train the ML model 204 based at least on the historical data for predicting the one or more peaks 802 in the flaring. The historical data may correspond to the repository of the flare data received from each of the one or more flare stacks 104 within a predefined time period. Further, the non-transitory machine-readable information storage medium may comprise one or more instructions which when executed by the at least one processor 200 cause the at least one processor 200 to determine the one or more parameter setpoints and the advisory information associated with the predicted one or more flare events. The one or more parameter setpoints may comprise at least one of change in pressure of upstream vessels of the one or more flare stacks 104, change in temperature of upstream vessels of the one or more flare stacks 104, or change in speed of rotating machinery of the one or more flare stacks 104. The advisory information may correspond to guidance and recommendations for an operation of each of the one or more flare stacks 104 based at least on compliance and economics of each of the one or more flare stacks 104, to eliminate or minimize the non-routine flaring 600.

Further, the non-transitory machine-readable information storage medium may comprise one or more instructions which when executed by the at least one processor 200 cause the at least one processor 200 to determine the one or more defective components from the one or more components associated with each of the one or more flare stacks 104, based at least on the prediction. Further, the non-transitory machine-readable information storage medium may comprise one or more instructions which when executed by the at least one processor 200 cause the at least one processor 200 to generate the one or more alerts corresponding to the one or more parameter setpoints, the advisory information, and the one or more defective components, for the user. Further, the non-transitory machine-readable information storage medium may comprise one or more instructions which when executed by the at least one processor 200 cause the at least one processor 200 to deploy the determined one or more parameter setpoints and the advisory information on each of the one or more flare stacks 104, to manage the flaring.

The present disclosure streamlines the process of flaring by the one or more flare stacks 104. Embodiments of the present invention may ensure a precise analysis of the flare data using the ML model 204. Embodiments of the present invention may determine the one or more peaks 802 in the flare data using the ML model 204. Embodiments of the present invention eliminate or minimize the routine flaring 500 by predicting the one or more peaks 802. Embodiments of the present invention may improve accuracy of the system 100 to detect the one or more faulty components. Embodiments of the present invention may improve flaring by categorizing the flaring into the routine flaring 500 and the non-routine flaring 600. Embodiments of the present invention may alert the user about the one or more parameter setpoints, the advisory information, and the one or more defective components.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, via at least one processor, flare data from one or more flare stacks in real time, wherein the flare data corresponds to mass or volume of gas flared within each of the one or more flare stacks, temperature of the gas flared, and pressure at which the gas is flared;
determining, via the at least one processor, one or more peaks within the flare data, using a machine learning (ML) model, wherein the one or more peaks having one or more parameters;
categorizing, via the at least one processor, the flare data of each of the one or more flare stacks into a routine flaring and a non-routine flaring, based at least on the one or more determined peaks having the one or more parameters, using the ML model;
predicting, via the at least one processor, one or more flare events within the flare data categorized in the routine flaring and the non-routine flaring, based at least on a historical data and a set of parameters, using the ML model, wherein the one or more flare events correspond to one or more peaks in flaring;
determining, via the at least one processor, one or more parameter setpoints and advisory information associated with the predicted one or more flare events; and
deploying, via the at least one processor, the determined one or more parameter setpoints and the advisory information on each of the one or more flare stacks, to manage the flaring.

2. The method of claim 1 further comprising training, via the at least one processor, the ML model based at least on the historical data for predicting the one or more peaks in the flaring, wherein the historical data corresponds to a repository of the flare data received from each of the one or more flare stacks within a predefined time period.

3. The method of claim 1, wherein the one or more parameters of the one or more peaks comprise at least one of start and stop time of the one or more peaks, and wherein the set of parameters comprises at least one of temperature and pressure of one or more components associated with each of the one or more flare stacks, control data, economics data, or compliance data.

4. The method of claim 3 further comprising determining, via the at least one processor, one or more defective components from the one or more components associated with each of the one or more flare stacks, based at least on the prediction.

5. The method of claim 4 further comprising generating, via the at least one processor, one or more alerts corresponding to the one or more parameter setpoints, the advisory information, and the one or more defective components, for a user.

6. The method of claim 1, wherein the one or more parameter setpoints comprise at least one of change in pressure of upstream vessels of the one or more flare stacks, change in temperature of upstream vessels of the one or more flare stacks, or change in speed of rotating machinery of the one or more flare stacks.

7. The method of claim 1, wherein the advisory information corresponds to guidance and recommendations for an operation of each of the one or more flare stacks based at least on compliance and economics of each of the one or more flare stacks, to eliminate or minimize the non-routine flaring.

8. A system comprising:
a memory; and
at least one processor communicatively coupled to the memory, wherein the at least one processor is configured to:
receive flare data from one or more flare stacks in real time, wherein the flare data corresponds to mass or volume of gas flared within each of the one or more flare stacks, temperature of the gas flared, and pressure at which the gas is flared;
determine one or more peaks within the flare data, using a machine learning (ML) model, wherein the one or more peaks having one or more parameters;
categorize the flare data of each of the one or more flare stacks into a routine flaring and a non-routine flaring, based at least on the one or more determined peaks having the one or more parameters, using the ML model;
predict one or more flare events within the flare data categorized in the routine flaring and the non-routine flaring, based at least on a historical data and a set of parameters, using the ML model, wherein the one or more flare events correspond to one or more peaks in flaring;
determine one or more parameter setpoints and advisory information associated with the predicted one or more flare events; and
deploy the determined one or more parameter setpoints and the advisory information on each of the one or more flare stacks, to manage the flaring.

9. The system of claim 8, wherein the at least one processor is configured to train the ML model based at least on the historical data for predicting the one or more peaks in the flaring, wherein the historical data corresponds to a repository of the flare data received from each of the one or more flare stacks within a predefined time period.

10. The system of claim 8, wherein the one or more parameters of the one or more peaks comprise at least one of start and stop time of the one or more peaks, and wherein the set of parameters comprises at least one of temperature and pressure of one or more components associated with each of the one or more flare stacks, control data, economics data, or compliance data.

11. The system of claim 10, wherein the at least one processor is configured to determine one or more defective components from the one or more components associated with each of the one or more flare stacks, based at least on the prediction.

12. The system of claim 11, wherein the at least one processor is configured to generate one or more alerts corresponding to the one or more parameter setpoints, the advisory information, and the one or more defective components, for a user.

13. The system of claim 8, wherein the one or more parameter setpoints comprise at least one of change in pressure of upstream vessels of the one or more flare stacks, change in temperature of upstream vessels of the one or more flare stacks, or change in speed of rotating machinery of the one or more flare stacks.

14. The system of claim 8, wherein the advisory information corresponds to guidance and recommendations for an operation of each of the one or more flare stacks based at least on compliance and economics of each of the one or more flare stacks, to eliminate or minimize the non-routine flaring.

15. A non-transitory machine-readable information storage medium comprising one or more instructions which when executed by at least one processor cause the at least one processor to:
receive flare data from one or more flare stacks in real time, wherein the flare data corresponds to mass or volume of gas flared within each of the one or more flare stacks, temperature of the gas flared, and pressure at which the gas is flared;
determine one or more peaks within the flare data, using a machine learning (ML) model, wherein the one or more peaks having one or more parameters;
categorize the flare data of each of the one or more flare stacks into a routine flaring and a non-routine flaring, based at least on the one or more determined peaks having the one or more parameters, using the ML model;
predict one or more flare events within the flare data categorized in the routine flaring and the non-routine flaring, based at least on a historical data and a set of parameters, using the ML model, wherein the one or more flare events correspond to one or more peaks in flaring;
determine one or more parameter setpoints and advisory information associated with the predicted one or more flare events; and
deploy the determined one or more parameter setpoints and the advisory information on each of the one or more flare stacks, to manage the flaring.

16. The non-transitory machine-readable information storage medium of claim 15, wherein the at least one processor is configured to train the ML model based at least on the historical data for predicting the one or more peaks in the flaring, wherein the historical data corresponds to a repository of the flare data received from each of the one or more flare stacks within a predefined time period.

17. The non-transitory machine-readable information storage medium of claim 15, wherein the one or more parameters of the one or more peaks comprise at least one of start and stop time of the one or more peaks, and wherein the set of parameters comprises at least one of temperature and pressure of one or more components associated with each of the one or more flare stacks, control data, economics data, or compliance data.

18. The non-transitory machine-readable information storage medium of claim 17, wherein the at least one processor is configured to determine one or more defective components from the one or more components associated with each of the one or more flare stacks, based at least on the prediction.

19. The non-transitory machine-readable information storage medium of claim 15, wherein the one or more parameter setpoints comprise at least one of change in pressure of upstream vessels of the one or more flare stacks, change in temperature of upstream vessels of the one or more flare stacks, or change in speed of rotating machinery of the one or more flare stacks.

20. The non-transitory machine-readable information storage medium of claim 15, wherein the advisory information corresponds to guidance and recommendations for an operation of each of the one or more flare stacks based at least on compliance and economics of each of the one or more flare stacks, to eliminate or minimize the non-routine flaring.
